(19) United States
(12) Patent Application Publication
(10) Pub. No.: US 2005/0003058 A1
(43) Pub. Date: Jan. 6, 2005

(54) Controlled modification of beverages

(76) Inventor: Shashidhar M. Prabhakar, Cambridge, MA (US)

Correspondence Address: BROMBERG & SUNSTEIN LLP, 125 SUMMER STREET, BOSTON, MA, 02110-1618, US

(21) Appl. No.: 10/839,074

(22) Filed: May 5, 2004

Related U.S. Application Data
(60) Provisional application No. 60/467,989, filed on May 5, 2003.

(51) Int. Cl. A23B 4/00

(52) U.S. Cl. 426/394

(57) ABSTRACT

A single-use beverage container includes a variable-volume package, a lower section, and an upper section. The variable-volume package encloses a variable-volume and has a first and a second portion. The lower section has a sidewall and a bottom and is sealingly coupled to the first portion at the sidewall or at the bottom. The upper section is sealingly coupled to the bottom section. The variable-volume package contains dispersible material that may be controllably injected into the container so as to modify a feature of the contents of the container.

The present application claims priority from U.S. provisional application 60/467,989, filed May 5, 2003 and hereby incorporated by reference.

### TECHNICAL FIELD

The present invention relates to beverage containers, and, in particular, to modification of the contents of beverage containers.

### BACKGROUND ART

Single-use containers filled with beverages, once filled and sealed at the site of manufacture, remain sealed until opened by a consumer. The consumer may select a type of beverage—for example, tea, cola, or beer—and, within that type, a particular variety.

If the consumer wishes tea, for example, the consumer may choose a regular caffeinated tea or a herbal decaffeinated tea—a caffeinated tea for a first beverage of the day to become awake and a decaffeinated before retiring so as not to encounter difficulty in falling asleep.

Often beverage characteristics such as content or appearance preferred by a consumer do not correspond to available selections. For more than usual assistance in awakening, the consumer may want a drink containing substantially more caffeine than available in caffeinated tea. For aid in staying awake for a limited amount of time—for example, after dinner—just a little more caffeine than is contained in the available herbal drink may be sufficient. A non-traditional color such as teal may be appealing in some circumstances.

Previous containers and methods for modifying beverage characteristics have involved adding fixed quantities of modifiers after opening a beverage container. These approaches lacked calibration means to allow control of the amount of modifier inserted. Further, because mixing had to occur after the beverage was opened, it was necessary to control for spillage.

### SUMMARY OF THE INVENTION

One embodiment of the invention allows individualized modification of the contents of single-use beverage containers both prior to and during consumption. A consumer of the beverage may choose from a selection of beverage modifiers, including taste and appearance, and may adjust the strength of the modification according to personal preference.

In accordance with one aspect of the invention, a single-use beverage container includes a variable-volume package, a lower section, and an upper section. The variable-volume package encloses a volume and includes a first portion and a second portion. The lower section includes a side wall and a bottom sealingly coupled to the first portion at the side wall or at the bottom. The upper section is sealingly coupled to the lower section.

In some embodiments, the variable-volume package may be collapsible or the first portion sealingly coupled to the second portion. The variable-volume package may include a disrupting means where the disrupting means includes a pointed structure that may include a plurality of radial segments. The variable-volume package may also include a dispersible material that may be a feature-modifier. The feature-modifier may be a taste-modifier, an appearance modifier, or a caffeination-modifier.

In other embodiments, the first portion of the variable-volume package may contain a disruptible region. The variable-volume package may further contain a porous element that may include a dispersible material.

In further embodiments, the variable-volume package may include means for varying the enclosed variable-volume of the variable-volume package. The varying means may include a plunger sealingly coupled to the first and second portions of the variable-volume package where the variable-volume package may contain means for indicating the varied enclosed volume.

In certain embodiments, the first portion may overlie an integral portion of the sidewall or the bottom of the lower section.

In still other embodiments, the container may include contents where the contents may be pressurized. Further, the pressurized contents may be carbonated.

In accordance with another aspect of the invention, the contents of a single-use beverage container having an interior defined by an upper section and a lower section containing a side wall and a bottom is altered by applying a first force to a first variable-volume package with an interior and sealingly coupled to the lower section, creating an opening between the interior of the container and the interior of the first variable-volume package, and introducing a portion of the contents of the first variable-volume package into the contents of the container so as to permit mixing of the contents of the first variable-volume package with the contents of the container.

In certain embodiments, less than all of the initial contents of the first variable-volume package may be introduced. A feature of the contents of the container may be ascertained and a second force applied to the first variable-volume package. In other embodiments, all of the initial contents of the first variable-volume package may be introduced.

In further embodiments, a feature of the contents of the container may be ascertained and a second force may be applied to a second variable-volume package coupled sealingly to the container.

In other embodiments, creating an opening may include creating an opening in the first portion of the variable-volume package and in the lower section of the container, displacing a cap sealingly coupled to the first portion of the variable-volume package where the displacing may include compressing a spring coupled to the cap, or rupturing the first portion of the variable-volume package where rupturing may include inserting a pointed element through the first portion of the variable-volume package.

In still another embodiment, applying a force may include applying a force substantially parallel to the sidewall of the container against a plunging element sealingly coupled to the variable-volume package.

In accordance with a further aspect of the invention, a variable-volume package for altering a feature of the contents of a sealed single-use beverage container includes means for altering the feature, means for sealingly attaching the variable-volume package to the container, means for creating an opening between an interior of the container and an interior of the variable-volume package, and means for controllably injecting a fraction of the contents of the variable-volume package into the interior of the container.

In accordance with an additional aspect of the invention, a single-use beverage container includes a variable-volume package sealingly coupled to an exterior of the container, and a disrupting means for permitting fluid communication between the variable-volume package and an interior of the container wherein the contents of the container are pressurized.

### BRIEF DESCRIPTION OF THE DRAWINGS

The foregoing features of the invention will be more readily understood by reference to the following detailed description, taken with reference to the accompanying drawings, in which:

FIGS. 1a, 1b, and 1c show examples of beverage containers.

FIGS. 2a and 2b illustrate attachment of a single button to a beverage container.

FIGS. 3a and 3b show examples of collapsible buttons.

FIGS. 4a, 4b, 4c, and 4d show examples of button opening means.

FIGS. 5a and 5b show an example of a patch.

FIGS. 6a and 6b show an example of a patch coupled with a beverage container.

FIGS. 7a and 7b show an example of an injector patch.

FIGS. 8a and 8b show an example of a injector patch coupled with a beverage container.

FIG. 9 illustrates a beverage container having multiple buttons.

### DETAILED DESCRIPTION OF SPECIFIC EMBODIMENTS

Beverages as furnished in containers such as cans, bottles, and cartons are available in different varieties—for example, diet, caffeine free, lime twist, vanilla, etc. Still, the variety of available beverages does not completely satisfy individual tastes or requirements. Some may find a beverage too sweet, too caffeinated, too far removed from the base flavor. Some may wish for presently unavailable combinations of ingredients—for example, lemon vanilla cola.

Others may wish for a visual experience in consuming a beverage. Instead of accepting a plain, uniform, and conventional color, they may wish to creatively customize the appearance of the drink—for example, adding colored swirls to ginger ale or sparkles to cola. Embodiments described below enable a consumer to controllably individualize a beverage.

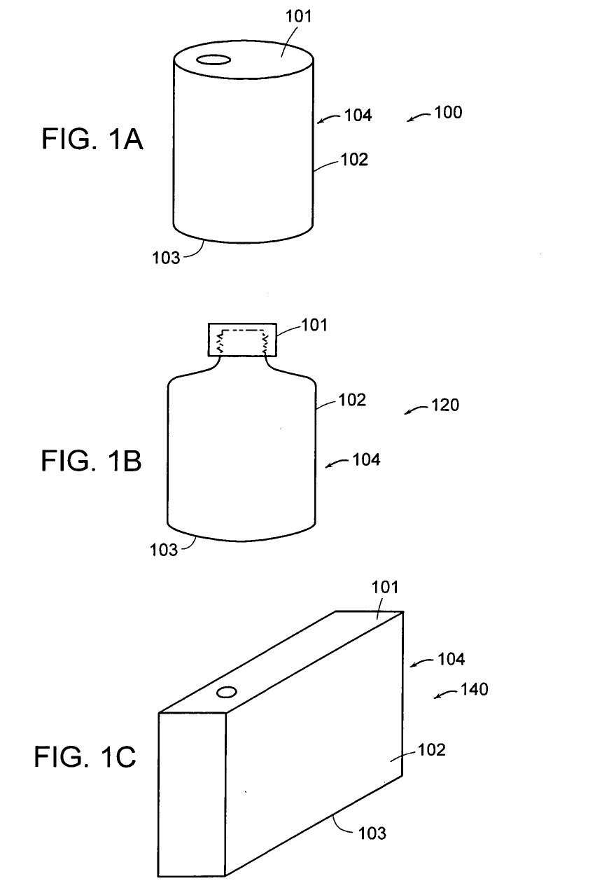

FIGS. 1a, 1b, and 1c illustrate three types of single-use beverage containers—a can 100 (FIG. 1a), a bottle 120 (FIG. 1b), and a carton 140 (FIG. 1c) where single use implies that, upon consumption of the beverage, usually at one sitting, the container may be discarded or returned for recycling. Each container includes a lower section 104 containing a sidewall 102 and a bottom 103. Coupled to the lower section 104 in a sealed manner is an upper section 101. Immediately before consumption, a portion of the top may be displaced (as in 100), removed (as in 120), or perforated (as in 140).

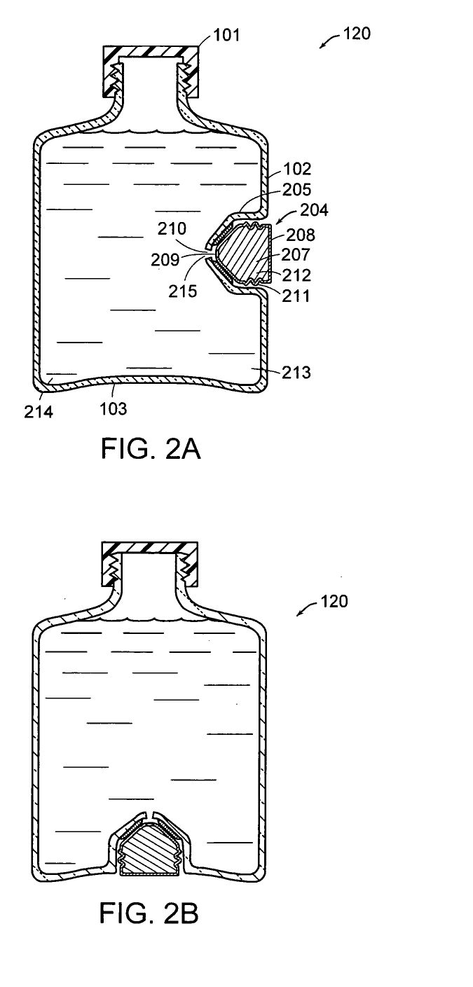

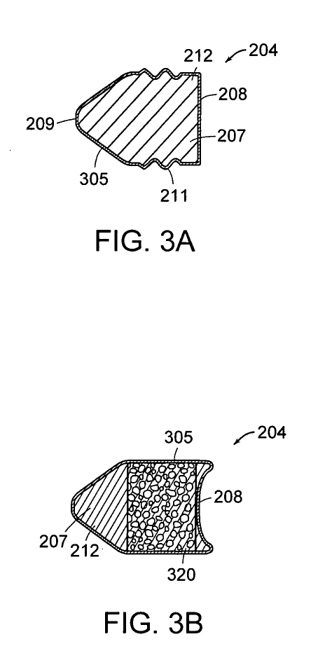

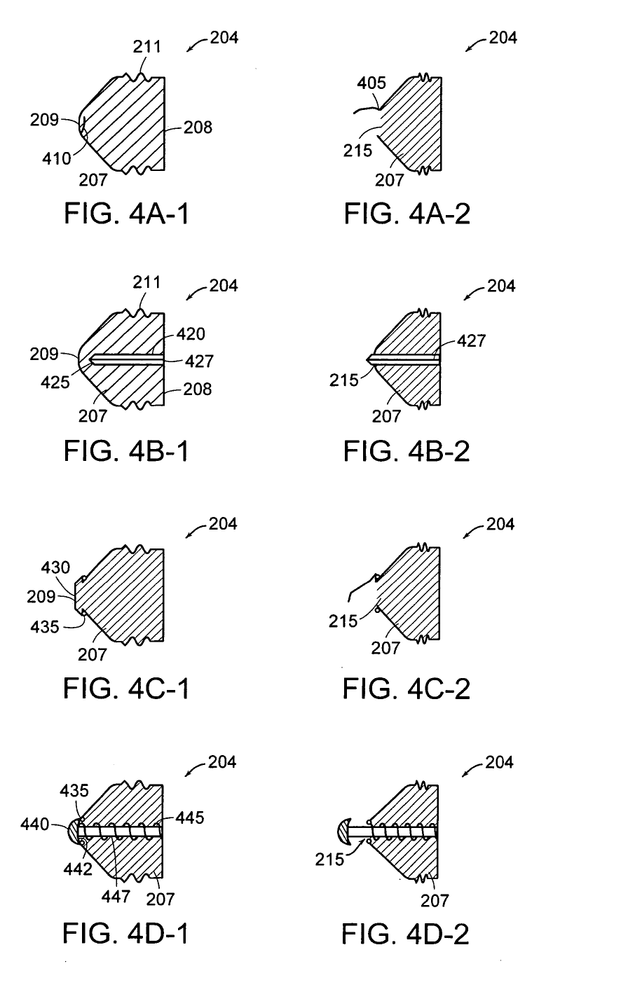

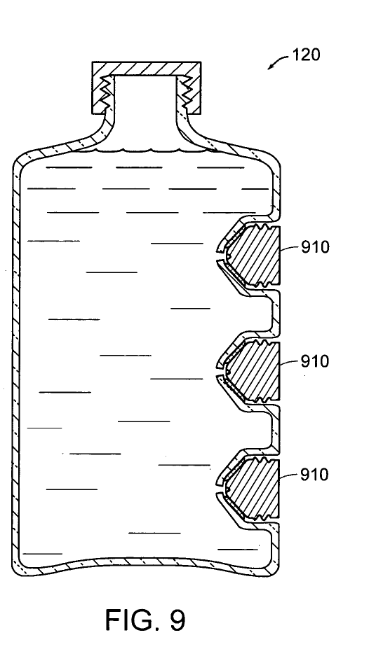

FIGS. 2a and 2b show examples of a single use beverage container 120 also including a variable-volume package 204 attached to sidewall 102 (FIG. 2a) or to bottom 103 (FIG. 2b). (In FIGS. 2a and 2b, as well as FIGS. 3a and 3b, and FIGS. 4a, 4b, 4c, and 4d, a variable-volume package 204 is also referred to as a button 204. In FIG. 9, variable-volume packages 910, 920, and 930 are referred to as buttons 910, 920, and 930.) In these embodiments, the button 204 is sealed to a recess 205 in the container 120. Sealing may be accomplished by any of several techniques, such as adhesives. Sealing may also permit subsequent separation of the empty button 204 from the empty container 120 in conjunction with recycling of either or both.

An opening 210 in the center of the recess 205 allows entry of the contents 207 of the button 204 as the second portion 208 of the button 204 is pushed toward the sidewall 102 and a first portion 209 of the button develops an opening 215. (In FIGS. 2a and 2b, as well as FIGS. 3a and 3b and FIGS. 4a, 4b, 4c, and 4d, second portion is referred to as back 208 and first portion is referred to as tip 209.) Corrugations 211 allow for compression of and variation of the volume within the button 204 as contents 207 are expelled from the interior 212 of the button 204 into the interior 213 of container 120 to mix with container contents 214.

FIGS. 3a and 3b illustrate means for control of the expulsion of the contents 207 of the button 204. FIG. 3a shows button 204 having an initially hollow interior 212 that may be filled with contents 207 corresponding to a modifier of a feature of the contents 214 of the container 120. Examples of features are appearance, caffeination, and taste, including sweetness, sourness, saltiness, bitterness, flavor (e.g., cherry, lemon, lime, vanilla, etc.) etc. The modifier may be injected into the interior 212 of the button 204 through the back 208 and the point of injection subsequently sealed.

The button 204 includes a wall 305 coupling the tip 209 and the back 208 and having corrugations 211 distributed circumferentially around the periphery between the tip 209 and the back 208 to allow for controlled compression of the interior 212 of the button 204 as the back 208 is pushed toward the tip 209. The button 204 may comprise a single piece including the tip 209, the back 208, and the wall 305 or various combinations of tip 209, back 208, and wall 305 sealingly coupled together.

FIG. 3b illustrates a button 204 containing a porous material 320 as well as a modifier contents 207 and having a flexible back 208 and wall 305. Upon application of pressure to the back 208, the porous material 320 is compressed and the modifier contents 207 expelled from the button 204. During compression, the back 208 telescopes into the interior 212 of the button 204.

In FIGS. 3a and 3b, expulsion of button contents 207 continues as long as pressure is applied to the back 208 and ceases upon removal of pressure. If cessation of pressure leaves the back 208 at its last position and if the contents 207 of the button 204 are not fully expelled, then one or more subsequent expulsions are possible as the consumer further modifies beverage attributes. If the corrugations 211 and the porous material 320 are resilient, then, upon cessation of pressure to back 208, the back 208 returns toward its original position, drawing in contents 214 from container 120 and priming button 204 for a subsequent expulsion of somewhat diluted contents 207.

FIGS. 4a, 4b, 4c, and 4d illustrate several means to create the opening 215 in the button 204 to permit expulsion of the contents 207 of the button 204. In FIG. 4a, a portion of the circumference in the vicinity of the tip 209 is weakened—for example, by scoring—relative to the remainder of the circumference, thereby corresponding to a disruptible region. Upon application of pressure to the back 208, the pressure within the button 204 increases sufficiently to separate the weakened portion of the tip 209 from the remainder of the button 204 such that the tip 209 is held to the remainder of the button 204 by the material 405 of the unweakened section.

In FIG. 4b, a pointed projection 420 is attached within button 104 to the back 208. As pressure is applied to the back 208, corrugations 211 compress, allowing a tip 425 of pointed projection 420 to move toward, impinge, and puncture or disrupt or rupture the tip 209 of button 204, thereby creating the opening 215 that permits expulsion of the contents 207 of the button 204. In order to ease the exit of material from the button 104, the tip 425 of the pointed projection 420 and a portion of the rest of the pointed projection 420 may contain one or more grooves 427 along the length of the pointed projection 420.

In FIG. 4c, a displaceable cap 430 serves as the tip 209 of the button 204. The cap 430 is sealingly coupled to the button 204 by engagement with a lip 435 formed on the button 204. As pressure is applied to the back 208, the pressure within button 204 increases until sufficient to displace cap 430 from lip 435. Thereafter, contents 207 of button 204 are expelled through the opening 215.

In FIG. 4d, a repeatedly displaceable cap 440 affixed to an end 442 of capped projection 447 is sealed against the lip 435 of opening 215 external to button 204 by a force generated by a spring 445 surrounding capped projection 447. Upon application of a force to back 208 and subsequent compression of spring 445, cap 440 is displaced from opening 215 and contents 207 of button 204 expelled. Upon release of the force, the cap 440 again seals against the lip 435, thereby closing opening 215 and preserving the remaining contents 207 of button 204 for a subsequent expulsion.

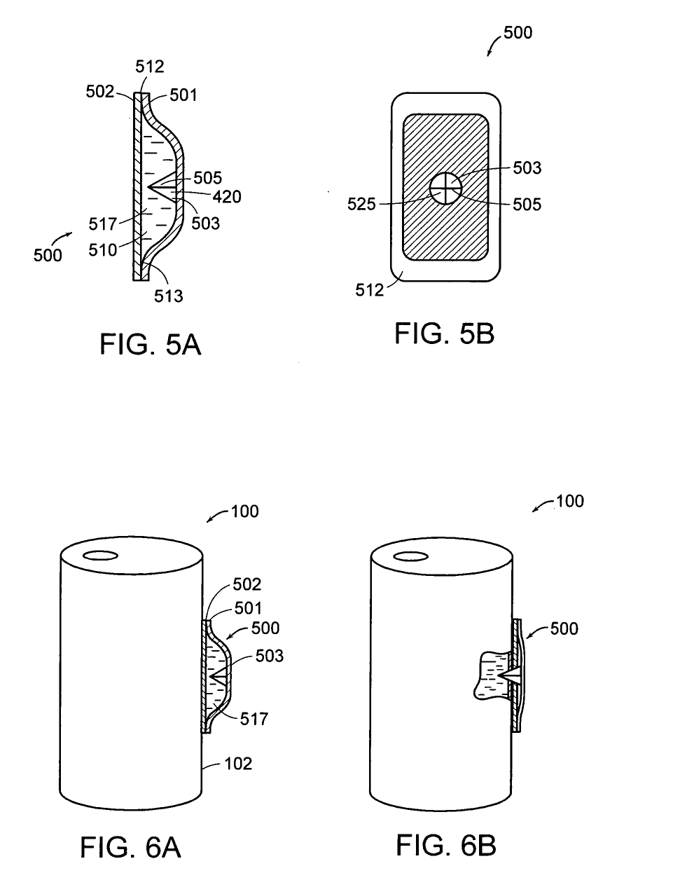

Other variable-volume packages for delivery of modifiers in addition to the button 204 described above may be considered. FIG. 5a shows a side view and FIG. 5b a top view of a variable-volume package in the form of a patch 500. Patch 500 includes a first portion 502 coupled to a second portion 501 around periphery 512 by seal 513 so as to create an interior 510 with contents 517 corresponding to modifying material. (In FIGS. 5a and 5b, as well as in FIGS. 6a and 6b, FIGS. 7a and 7b, and FIGS. 8a and 8b, first portion 502 is referred to as first layer 502 and second portion 501 is referred to as second layer 501.) Attached to the second layer 501 and projecting into the interior 510 is a pointed projection 420 that may contain flutes 505. As force is applied to the second layer 501, the pointed projection 420 moves toward and punctures the first layer 502. Expulsion of the contents of patch 500 from the interior 510 is eased by the channels 525 positioned between the flutes 505.

Patch 500 made of compliant first layer 502 and compliant second layer 501 permits attachment on a curved single-use container 100 and does not require a recess 205 or an opening 210 (as shown in FIG. 2a) in the sidewall 102 or bottom 103. FIG. 6a shows attachment of the patch 500 to the sidewall 102 of the beverage container 100. The patch 500 may be sealingly coupled to the sidewall 102 before or after the container 100 is filled with beverage.

FIG. 6b shows expulsion of the contents 517 of the patch 500 after application of pressure to the second layer 501. As pressure is applied to the second layer 501, the pointed projection 420 first punctures the first layer 502 and then punctures the sidewall 102, thereby injecting patch contents 517 into the container 100. If the second layer 501 is made of an optically clear material, then the amount of contents 517 remaining in patch 500 may be ascertained.

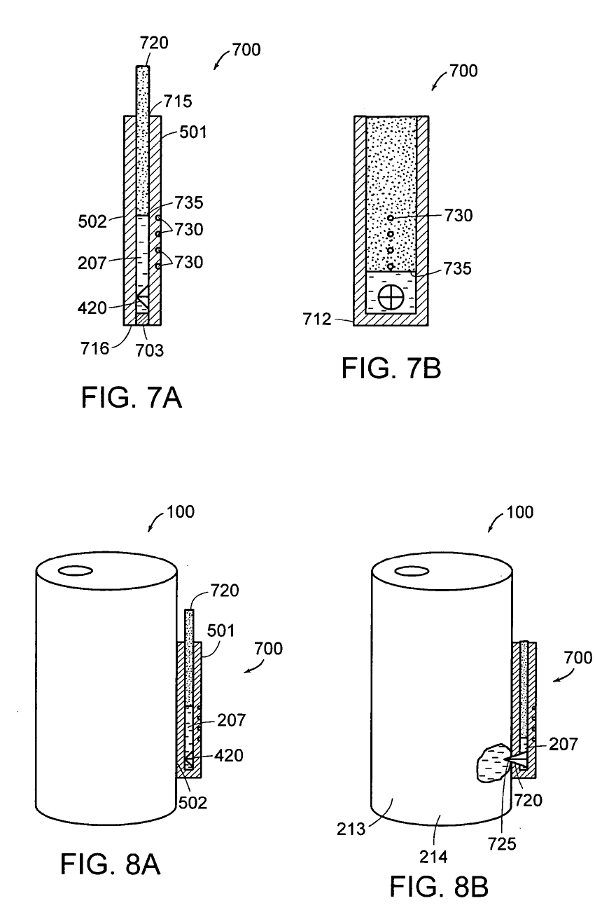

There are other means to controllably insert modifiers into a container. FIG. 7a and FIG. 7b show respectively a side view and a front view of an injector patch or variable-volume package 700 that employs positive displacement of modifier from the injector patch 700 without collapse of the injector patch 700. Injector patch 700 includes a first layer 502 and a second layer 501 sealed at the periphery 712 except at open end 715. Plunging element or plunger 720 is inserted in open end 715 and sealingly engages first layer 502 and second layer 501 and any spacer 703 that may hold them apart. Adjacent to the closed end 716 is a pointed element 420. Present on the second layer 501 are indicators 730 that may be painted on or embossed into second layer 501. From the position of the end 735 of plunger 720 relative to indicators 730, the amount of modifier contents remaining in the injector patch 700 may be determined.

The injector patch 700 may be sealed to a container 100 before or after the container 100 is filled (FIG. 8a). To modify a beverage, the second layer 501 is pressed to move the pointed element 420 to create an opening 720 in first layer 502 and an opening 725 in sidewall 102. The plunger 720 is then depressed to inject some of injector patch contents 207 into the container interior 213. A known amount of injector patch contents 207 can be injected by referring to the final position of the end 735 of plunger 720 relative to the indicators 730.

To mix injected contents 207 with container contents 214, container 100 may be rotated or shaken. Since the container 100 remains sealed after injection of the variable-volume package contents 207, pressurized drinks such as carbonated beverages may be mixed. However, in the case of carbonated beverages, motions of the container 100 to achieve mixing are gentle to avoid an undesired increase in pressure within the container 6100. In the event that contents 207 are injected after the container 100 is opened, mixing may be accomplished by gentle movement of the container 100 or by stirring with an implement inserted into the container 100.

Although the embodiments shown above included only one variable-volume package attached to containers, multiple variable-volume packages may also be attached. In this manner, a consumer can modify a beverage by injecting combinations of modifiers. FIG. 9 shows an embodiment where a container 120 is fitted with three buttons (910, 920, and 930). If the contents 214 are tea, then button 910 may contain a lemon concentrate, button 920 may contain a liquid sugar, and button 930 may contain a liquid sugar substitute, thereby allowing one consumer to have tea with lemon and sugar and another consumer to have tea with a sugar substitute.

Further, the same modification need not be maintained for the entire beverage. As the beverage is consumed, the contents 214 may be further modified, as, for example, by injecting additional sugar to increase sweetness.

Although various exemplary embodiments of the invention are disclosed above, it should be apparent that those skilled in the art can make various changes and modifications that will achieve some of the advantages of the invention without departing from the true scope of the invention.

1. A single-use beverage container, the container including:
a variable-volume package, the variable-volume package enclosing a variable-volume and including a first portion and a second portion;
a lower section, the lower section including a side wall and a bottom and sealingly coupled to the first portion of the variable-volume package at the side wall or at the bottom; and
an upper section, the upper section sealingly coupled to the lower section.

2. A container according to claim 1, wherein the variable-volume package is collapsible.

3. A container according to claim 1, wherein the first portion is sealingly coupled to the second portion.

4. A container according to claim 2, the collapsible variable-volume package including a disrupting means.

5. A container according to claim 4, the disrupting means including a pointed projection.

6. A container according to claim 5, the pointed projection including a plurality of radial segments.

7. A container according to claim 4, the collapsible variable-volume package further including a dispersible material.

8. A container according to claim 7, wherein the dispersible material is a feature-modifier.

9. A container according to claim 8, wherein the feature-modifier is a taste-modifier.

10. A container according to claim 8, wherein the feature-modifier is an appearance-modifier.

11. A container according to claim 8, wherein the feature-modifier is a caffeination-modifier.

12. A container according to claim 4, the first portion including a disruptible region.

13. A container according to claim 12, the collapsible variable-volume package further including a porous element.

14. A container according to claim 13, the porous element including a dispersible material.

15. A container according to claim 14, wherein the dispersible material is a feature-modifier.

16. A container according to claim 15, wherein the feature-modifier is a taste-modifier.

17. A container according to claim 15, wherein the feature-modifier is an appearance-modifier.

18. A container according to claim 15, wherein the feature-modifier is a caffeination-modifier.

19. A container according to claim 1, the variable-volume package further including means for varying the enclosed variable-volume of the variable-volume package.

20. A container according to claim 19, wherein the varying means is a plunger sealingly coupled to the first and second portions of the variable-volume package.

21. A container according to claim 19, the variable-volume package further including means for indicating the varied enclosed volume.

22. A container according to claim 19, further including a dispersible material filling the variable enclosed volume.

23. A container according to claim 22, wherein the dispersible material is a feature-modifier.

24. A container according to claim 23, wherein the feature-modifier is a taste-modifier.

25. A container according to claim 23, wherein the feature-modifier is an appearance-modifier.

26. A container according to claim 23, wherein the feature-modifier is a caffeination-modifier.

27. A container according to claim 1, wherein the first portion overlies an integral portion of the side wall or the bottom of the lower section.

28. A container according to claim 1, further including contents.

29. A container according to claim 28, wherein the contents of the container are pressurized.

30. A container according to claim 29, wherein the contents of the container are carbonated.

31. A method for altering the contents of a single-use beverage container having an interior defined by an upper section and a lower section, the lower section containing a sidewall and a bottom, the method including:
applying a first force to a first variable-volume package having an interior, the first variable-volume package coupled sealingly to the lower section of the container;
creating an opening between the interior of the container and the interior of the first variable-volume package; and
introducing a portion of the contents of the first variable-volume package into the contents of the container so as to permit mixing of the contents of the first variable-volume package with the contents of the container.

32. A method according to claim 31, wherein introducing a portion of the contents of the first variable-volume package includes introducing less than all of the initial contents of the first variable-volume package.

33. A method according to claim 32, further including ascertaining a feature of the contents of the container and applying a second force to the first variable-volume package.

34. A method according to claim 31, wherein introducing a portion of the contents of the first variable-volume package includes introducing all of the initial contents of the first variable-volume package.

35. A method according to claim 31, further including ascertaining a feature of the contents of the container and applying a second force to a second variable-volume package, the second variable-volume package coupled sealingly to the container.

36. A method according to claim 31, wherein creating an opening includes creating an opening in the first portion of the variable-volume package and in the lower section of the container.

37. A method according to claim 31, wherein creating an opening includes displacing a cap sealingly coupled to the first portion of the variable-volume package.

38. A method according to claim 37, wherein displacing a cap includes compressing a spring coupled to the cap.

39. A method according to claim 31, wherein creating an opening includes rupturing the first portion of the variable-volume package.

40. A method according to claim 39, wherein rupturing includes inserting a pointed projection through the first portion of the variable-volume package.

41. A method according to claim 31, wherein applying a force includes applying a force substantially parallel to the sidewall of the container against a plunging element sealingly coupled to the variable-volume package.

42. A variable-volume package for altering a feature of a contents of a single-use beverage container, the variable-volume package including:
means for altering the feature;
means for sealingly attaching the variable-volume package to the container;
means for creating an opening between an interior of the container and an interior of the variable-volume package; and
means for controllably injecting a fraction of the contents of the variable-volume package into the interior of the container.

43. A variable-volume package according to claim 42, wherein the single-use beverage container is sealed.

44. A single-use beverage container, the container including:
a variable-volume package, the variable-volume package being sealingly coupled to an exterior of the container; and
a disrupting means for permitting fluid communication between the variable-volume package and an interior of the container,
wherein contents of the container are pressurized.
